(19) United States
(12) Patent Application Publication
(10) Pub. No.: US 2009/0219566 A1
(43) Pub. Date: Sep. 3, 2009

(54) IMAGE FORMING APPARATUS, SECURITY CONTROL METHOD AND SECURITY PROCESSING PROGRAM

(76) Inventors: Yoshinori Tanaka, Tokyo (JP); Masahiro Ozawa, Tokyo (JP); Jun Kuroki, Sagamihara-shi (JP); Hiroshi Nogawa, Tokyo (JP); Fumihito Akiyama, Yokohama-shi (JP); Yasufumi Aoyama, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/364,963

(22) Filed: Feb. 3, 2009

(30) Foreign Application Priority Data
Feb. 6, 2008 (JP) JP2008-025961

(51) Int. Cl. G06F 3/12

(52) U.S. Cl. 358/1.15

(57) ABSTRACT

A method of security control in an image forming apparatus that carries out print processing based on XPS data, which includes, at least, a first step of decompressing compressed XPS data in a secondary storage device (for example, an HDD), a second step of converting the decompressed XPS data into bit map data, a third step of carrying out print processing based on said bit map data, and a fourth step of specifying the elements having levels of importance above a prescribed level, which has been set in advance among constituent elements of said XPS data decompressed in a secondary storage device, and erasing the specified elements by overwriting after said print processing.

### BACKGROUND OF THE INVENTION

The present invention relates to image forming apparatus and security control method, together with security processing program, and in particular to an image forming apparatus that ensures security at the time of printing XPS (XML Paper Specification) data and to its security control method together with security processing program.

Printing apparatuses (hereinafter called image forming apparatuses) such as printers or digital multi function peripherals have come into widespread use. When such an image forming apparatus is used as a network printer, firstly, a document data is prepared using an application of the computer terminal connected to the network. Next, using a device driver (printer driver) of the computer terminal, the document data is converted into print data in the PDL (Page Description Language) format and is sent to the image forming apparatus. Then, in the image forming apparatus, the print data is analyzed and output on sheets.

In this context, as applications for preparing documents, applications have been known that operate based on a specification called XPS that describes the document in the XML (Extensible Markup Language) format. The data prepared based on this XPS (hereinafter called XPS data) can be displayed using Internet Explorer (Registered Trademark). Further, it is possible to store font data in XPS, and it is possible to print in the same form as has been displayed on the screen. Also, regarding the above XPS, its details have been disclosed, for example, in XML Paper Specification Version 1.0 (http://www.microsoft.com/japan/whdc/XPS/XPSspec.mspx).

Since the above XPS data is compressed and sent to an image forming apparatus, and is decompressed and stored once in an HDD at the time of print processing, the XPS data is not erased but remains even after the print processing has ended. Because of this, a malicious user can obtain XPS data from the HDD, and security cannot be ensured.

Regarding this problem, overwriting and erasing the XPS data decompressed in the HDD using various algorithms can be thought of. However, since the access speed of an HDD is slow, it takes time to overwrite and erase all the XPS data, there is the problem that, in the meantime, the CPU will be engaged, and the processing of the image forming apparatus will be delayed.

Although not related to the above technology of printing XPS data, as a technology of erasing the stored job data, the Japanese Unexamined Patent Application Publication No. 2004-288049 has been known. This Japanese Unexamined Patent Application Publication discloses a method, at the time of storing the job data necessary for executing a job, of storing a part of the job data in the RAM and the remaining in the HDD, and of erasing a part of the job data in the RAM at the time the job ends.

The technology disclosed in Japanese Unexamined Patent Application Publication No. 2004-288049 is one in which the job data is stored distributing it between the HDD and the RAM, and the data stored in the RAM is erased, and the data in the RAM can be erased at a high speed. However, since which part of the job data to store in the RAM is determined based on the free space in the RAM, in the case where confidential information is included in the data stored in the HDD, security cannot be ensured even if the data in the RAM is erased.

### SUMMARY

The present invention was made in view of the above problem, and the main purpose of the present invention is to provide image forming apparatuses and security control methods together with security processing programs whereby the time required for erasing XPS data can be shorten while ensuring security at the time of printing XPS data.

To achieve at least one of the abovementioned objects, an image forming apparatus reflecting one aspect of the present invention, that receives XPS data and carries out print processing based on the XPS data, comprises: a secondary storage device that stores said XPS data after decompression thereof; and a security processing section that specifies the elements that have previously set levels of importance more or not less than a predetermined level from the constituent elements of the XPS data decompressed in said secondary storage device, and erases those specified elements by overwriting after said print processing.

In the abovementioned image forming apparatus, the predetermined level is preferably set based on a command added in advance to the XPS data. Further, in the above mentioned image forming apparatus, the element having the level of importance more or not less than the predetermined level includes at least one of page information, image data, thumbnail data, Print Ticket and font data.

### BRIEF DESCRIPTION OF THE DRAWINGS

FIG. 1 is a diagram showing schematically the configuration of a printing system according to a first preferred embodiment of the present invention.

FIG. 2 is a block diagram showing the configuration of the computer terminal according to a first preferred embodiment of the present invention.

FIG. 3 is a block diagram showing the configuration of an image forming apparatus according to a first preferred embodiment of the present invention.

FIG. 4 is a diagram showing the structure of XPS data.

FIG. 5 is a flow chart showing the print processing of generally used XPS data.

FIG. 6 is a flow chart showing the details of the spooling processing in the print processing of generally used XPS data.

FIG. 7 is a flow chart showing the details of the decompression processing in the print processing of generally used XPS data.

FIG. 8 is a flow chart showing the print processing of XPS data according to a first preferred embodiment of the present invention.

FIG. 9 is a flow chart showing the details of the security processing in the print processing of XPS data according to a first preferred embodiment of the present invention.

FIG. 10 is a diagram showing a concrete structure of XPS data.

FIG. 11 is a flow chart showing the details of the security processing in the print processing of XPS data according to a second preferred embodiment of the present invention.

### DETAILED DESCRIPTION OF THE PREFERRED EMBODIMENTS

XPS data is known as document data, and when printing using this XPS data, in the image forming apparatus, because of decompressing and storing the XPS data in a secondary storage device such as an HDD, the problem arises that the XPS data remains in the secondary storage device after printing, and security cannot be ensured.

Regarding this problem, overwriting and erasing all the XPS data inside the secondary storage device can be thought of; however in this method, it takes time for erasing the data, the CPU will be engaged for a long time, and the processing in the image forming apparatus will be delayed. Further, a method can be considered in which the data is stored by dividing it between the HDD and the RAM; however in this method, security cannot be ensured in the case in which confidential information is included in the data inside the HDD.

In view of this, in the present preferred embodiments, a method is adopted of not erasing all the data stored in the secondary storage device such as an HDD, but of using the features in the structure of the XPS data, and overwriting and erasing only the elements in the XPS data that are important for ensuring security. Because of this, it is possible to shorten the time required for overwriting and erasing while ensuring security and to prevent the delay in the processing of the image forming apparatus.

### Preferred Embodiment 1

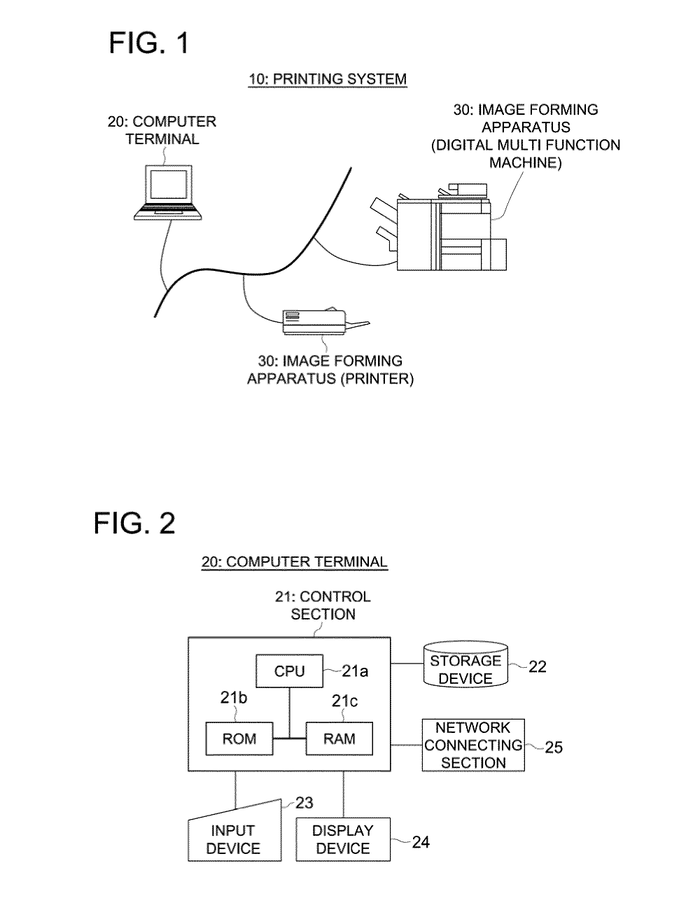

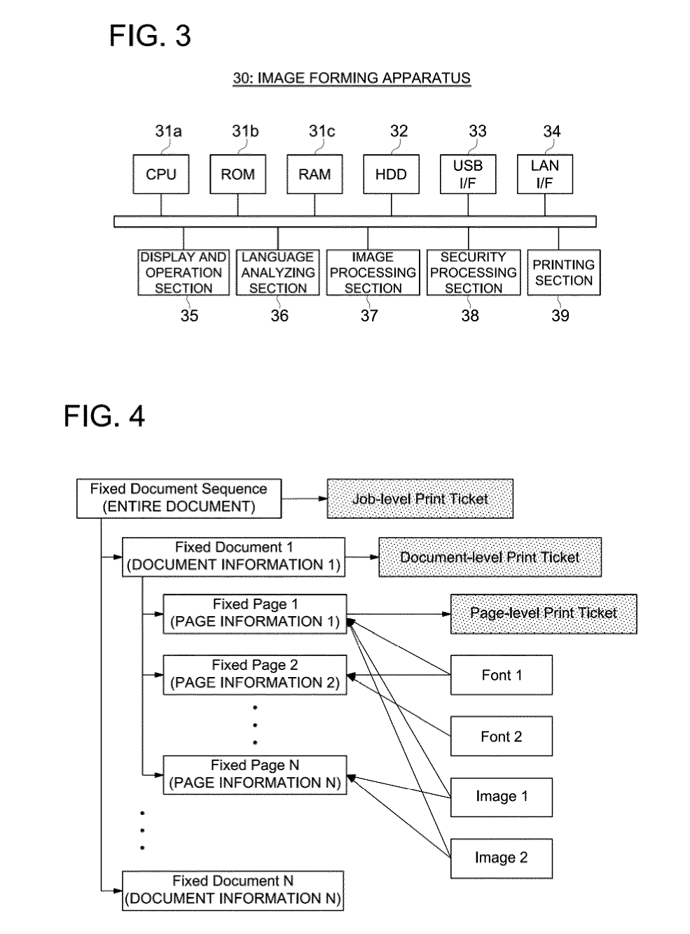

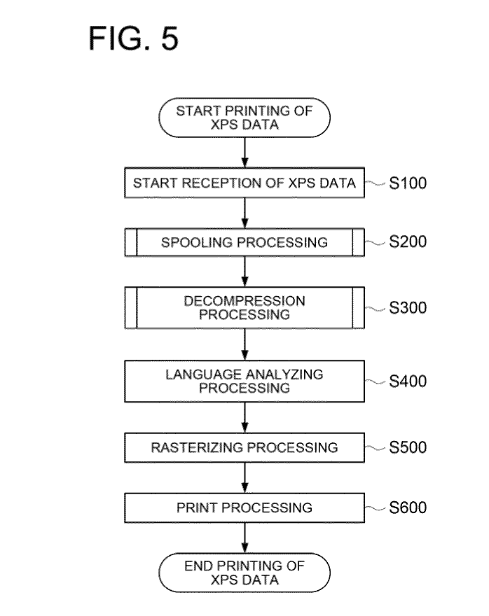

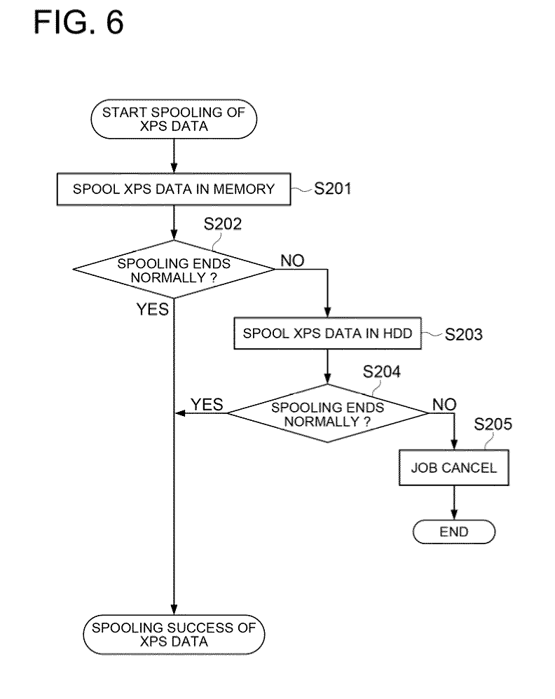

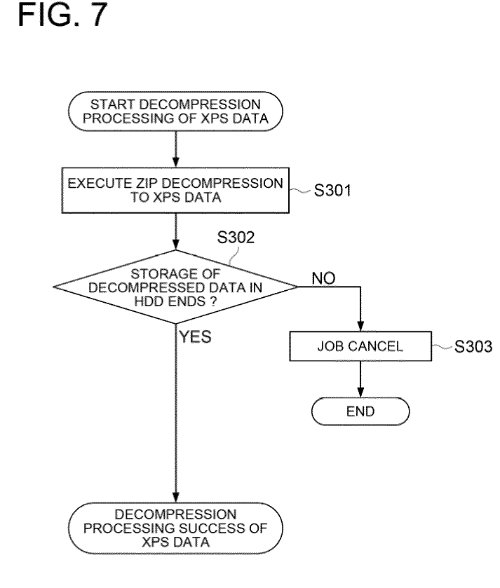

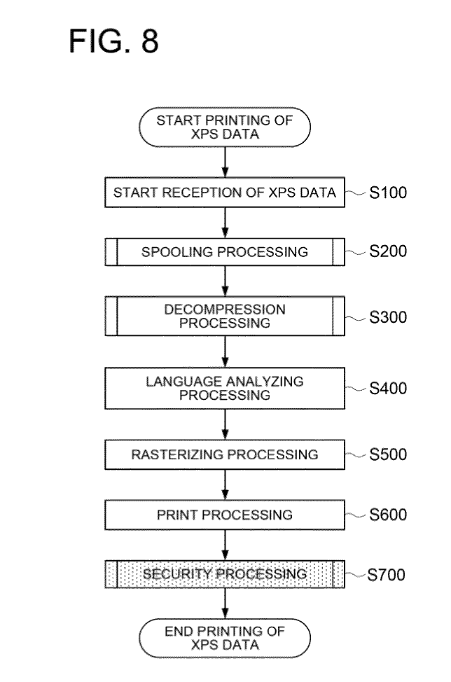

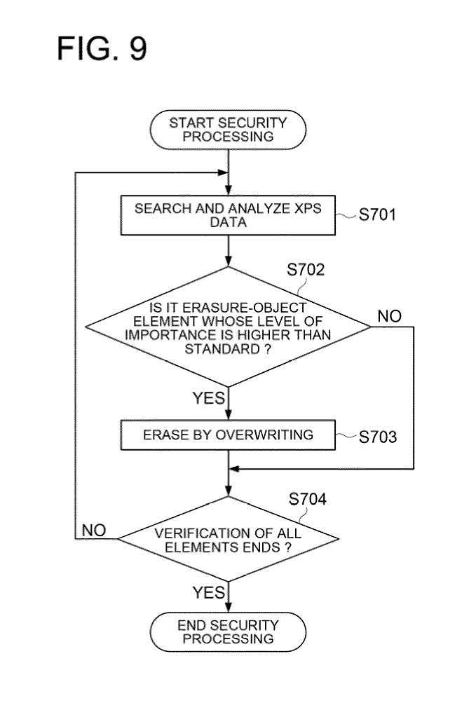

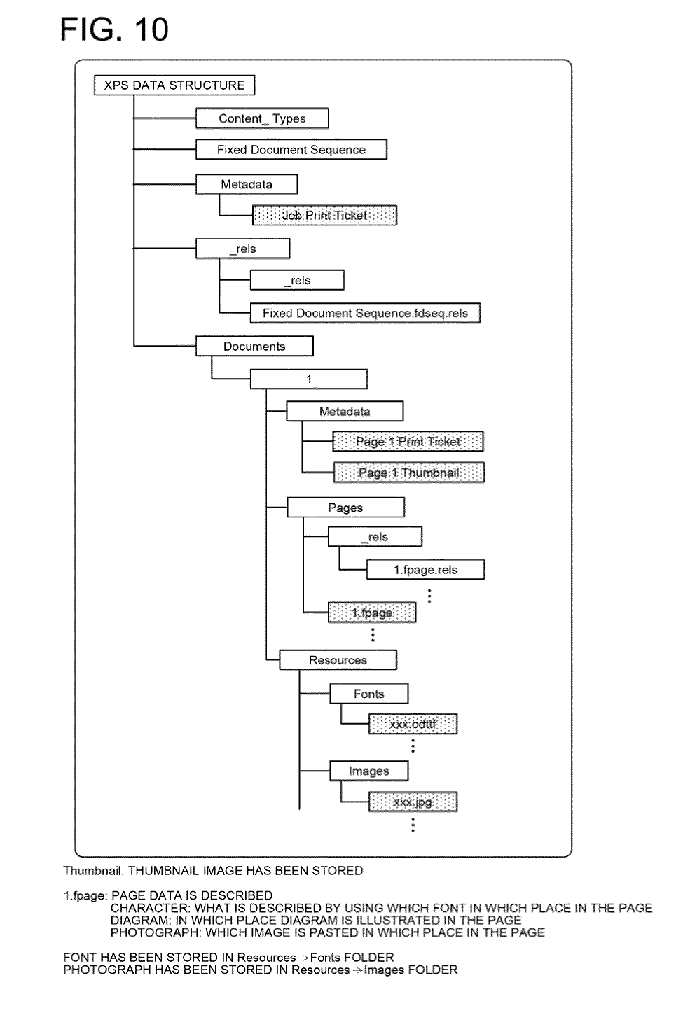

In order to describe in further detail the preferred embodiments of the present invention mentioned above, the image forming apparatus and the security control method together with the security processing program according to a first preferred embodiment of the present invention are described below with reference to FIG. 1 to FIG. 10. FIG. 1 is a diagram showing schematically the configuration of a printing system according to the present preferred embodiment, FIG. 2 is a block diagram showing the configuration of the computer terminal, and FIG. 3 is a block diagram showing the configuration of an image forming apparatus. Further, FIG. 4 is a diagram showing the structure of XPS data. In addition, FIG. 5 is a flow chart showing the print processing of generally used XPS data, FIG. 6 is a flow chart showing the details of the spooling processing, and FIG. 7 is a flow chart showing the details of the decompression processing. Furthermore, FIG. 8 is a flow chart showing the print processing of XPS data according to the present preferred embodiment, and FIG. 9 is a flow chart showing the details of the security processing. In addition, FIG. 10 is a diagram showing the concrete structure of an XPS data.

As shown in FIG. 1, The printing system 10 according to the present preferred embodiment, has one or a plurality of computer terminals 20 that are provided with applications that prepare documents based on standards such as XPS, prepare documents using such applications, and transmit the print data, and the printing system has one or a plurality of image forming apparatuses 30 such as a printer or digital multi function printer that prints documents based on the print data. These computer terminals 20 and the image forming apparatuses 30 are connected via a communication network such as a LAN (Local Area Network) or a WAN (Wide Area Network).

Further, as shown in FIG. 2, a computer terminal 20 is provided with a control section 21, a storage device 22, an input device 23, a display device 24, and a network connecting section 25 and others.

The control section 21 is configured using a CPU (Central Processing Unit) 21a and memory sections such as a ROM (Read Only Memory) 21b and a RAM (Random Access Memory) 21c, that are connected to the CPU 21a. The application preparing documents is, usually, read out into the RAM 21c from the ROM 21b or the storage device 22, and the print request from the application is conveyed from the CPU 21a to the image forming apparatus 30 connected via a communication network, and the printing is carried out in the image forming apparatus 30. This application is the Internet Explorer or the like.

The storage device 22 is configured using an HDD (Hard Disk Drive) or the like, and stores various types of programs and data.

The input device 23 is configured using a mouse and a keyboard and others, and carries out instructions for document preparation, printing and others.

The display device 24 is configured using an LCD (Liquid Crystal Display) or the like, and displays the prepared document or the print setting screens and others.

The network connecting section 25 is configured using an NIC (Network interface Card), a modem or the like, and connects to an image forming apparatus 30 via a communication network.

Further, in FIG. 1, although a personal computer is shown as the computer terminal 20, the computer terminals 20 according to the present preferred embodiment need only be an apparatus that can give print instructions using XPS data, and its form is not particularly restricted.

Further, as shown in FIG. 3, the image forming apparatus 30 is configured using a CPU 31a, ROM 31b, RAM 31c, HDD 32, USB I/F 33, LAN I/F 34, display and operation section 35, language analyzing section 36, image processing section 37, security processing section 38, printing section 39 and others, and these are connected via a bus.

The ROM 31b stores programs and others and others for controlling the operations of the entire image forming apparatus. The RAM 31c stores data necessary for the control by the CPU 31a and data that requires temporary storage during the control operation. Further, the CPU 31a, in coordination with the ROM 31b and the RAM 31c, functions as a control section that controls the operations of the entire image forming apparatus.

The HDD 32 is a secondary storage device, and stores the XPS data after decompression, and other data.

The LAN I/F 34 is an interface for connecting to a communication network such as an NIC or a modem, and connects with the computer terminals 20 via the communication network.

The USB I/F 33 is an interface for connecting devices such as an USB (Universal Serial Bus) memory.

The display and operation section 35 is configured using a display section such as an LCD and an operation section such as a touch panel that covers the display section, and not only displays various icons or key buttons, and various types of settings necessary for printing on the LCD in accordance with the display signal from the CPU 31a, but also outputs the operation signals inputted from the touch panel to the CPU 31a.

The language analyzing section 36 analyses the print data (XPS data, data described in a page description language (PDL) such as PS (Post Script) or PCL (Printer Control Language), PDF (Portable Document Format) data or the like, that has been inputted from the computer terminals 20 via the LAN I/F 34 and generates the data in an intermediate format (hereinafter called the intermediate data) before the print data is expanded into the data in the bit map format (hereinafter called bit map data).

The image processing section 37 prepares the printable bit map data from the intermediate data prepared by the language analyzing section 36.

The security processing section 38 analyzes the XPS data decompressed and stored in a secondary storage device such as the HDD 32 and, according to some rules determined in advance, specifies the elements in the XPS data that are important for ensuring security, and processes the specified elements so that they cannot be recovered from the HDD 32.

The printing section 39 carries out printing based on the bit map data prepared by the image processing section 37. In specific terms, the processing is done by emitting light from the exposure unit according to the bit map data onto a photoreceptor drum charged by an charging unit thereby forming an electrostatic latent image, developing it by making charged toner adhere to it in the developing unit, and transferring that toner image onto the recording medium via a primary transfer roller and a secondary transfer belt, and fixing it using the fixing unit.

Further, in FIG. 3, although the security processing section 38 was configured separately from the control section configured using the CPU 31a, the ROM 31b, and the RAM 31c, it is also possible to configure it as a security processing program that makes the computer function as a security processing section 38, and to make this security processing program operate in the control section. Further, in FIG. 1, although the printing system 10 was configured using computer terminals 20 and image forming apparatuses 30, for example, when an RIP (Raster Image Processor) controller is connected to the network and the RIP controller is made to function as the language analyzing section 36 and the image processing section 37, the security processing section 38 can also be provided in the RIP controller.

In the following, before the procedure of printing XPS data using a printing system 10 with the above configuration is described, in order to ease the understanding of the present preferred embodiment, the structure of an XPS data is described here.

According to the specifications, the XPS data is to be compressed into the ZIP format, and an XPS data after ZIP decompression has a structure as shown in FIG. 4. In FIG. 4, the plain background parts are the mandatory elements, and the hatched parts are elements that can be added optionally. The mandatory elements are constituted by the Fixed Document Sequence that stores the information of an entire document, the Fixed Document that stores the information of all the pages, the Fixed Page that stores the information of each page, Font that stores fonts, and Image that stores images. The optional elements are constituted by the Print Ticket that stores the print setting information of Job-level, Document-level, or Page-Level, and other elements. Further, the Fixed Document parts are referred from the Fixed Document Sequence part, and the Fixed Page parts are referred from the fixed Document parts.

An ordinary procedure of printing an XPS data of the above structure is described below referring to the flow chart of FIG. 5.

To begin with, in Step S100, the image forming apparatus 30 receives the XPS data from a computer terminal 20 via the LAN I/F 34.

Next, in Step S200, the control section of the image forming apparatus 30 carries out spooling processing of the received XPS data. When this processing is shown in concrete terms, it is found in FIG. 6, and firstly, in Step S201, the XPS data is spooled inside the memory (RAM 31c). Next, in Step S202, a judgment is made as to whether or not the spooling ended normally, and if the spooling has ended normally, the spooling processing is ended. On the other hand, if the spooling has not ended normally (for example, if the size of the XPS data exceeds the free area in the RAM 31c), in Step S203, the XPS data is spooled inside the HDD 32. Next, in Step S204, a judgment is made as to whether the spooling has ended normally or not, and if it has ended normally, the spooling processing is ended. On the other hand, if the spooling has not ended normally, in Step S205, the job is cancelled and the processing is ended.

Next, in Step S300, the control section decompresses the spooled XPS data and expands it in the HDD 32. This processing is shown in concrete terms in FIG. 7, in which, to begin with, in Step S301, the XPS data is decompressed from the ZIP format into its original format. Next, in Step S302, a judgment is made as to whether or not the storing of the decompressed data in the HDD 32 has been completed, and the decompression processing is ended if the storing of decompressed data has been completed. On the other hand, if the storing of the decompressed data has not been completed, (for example, when the decompression processing has failed, or when the size of the decompressed data has exceeded the free capacity of the HDD 32), in Step S303, the job is cancelled and the processing is ended.

Next, in Step S400, the language analyzing section 36 carries out analysis processing of the decompressed data, and generates the intermediate data.

Next, in Step S500, the image processing section 37 carries out rasterizing processing on the prepared intermediate data and generates the bit map data.

Further, in Step S600, the printing section 39 transfers the bit map data to the sheet and outputs it, whereupon the sequence of operations is ended.

Here, in the case of XPS, in order to carry out language analysis processing after ZIP decompression as described above, it is necessary to store the data once in a secondary storage device such as the HDD 32. Because of this, there is danger that the ZIP decompressed XPS data can be read out by other people, and there is the problem that security cannot be ensured.

In view of this problem, although it is possible to think of a method of erasing all the ZIP decompressed XPS data from the secondary storage device such as the HDD 32, since the size of the ZIP decompressed XPS data is large, in this method, it takes a long time to erase the data from the HDD 32, and a delay will be caused in the processing. On the other hand, the XPS data is constituted of various elements, as shown in FIG. 4, and the degree of importance in terms of security is different for different elements.

In view of this, in the present preferred embodiment, all the elements of the XPS data decompressed in a secondary storage device such as the HDD 32 are not erased, but, considering the importance in terms of security, only the elements having levels of importance above a level determined in advance are erased, thereby ensuring the security of XPS data while preventing delay in the processing.

The procedure of printing XPS data in this case becomes as shown in FIG. 8, and the XPS security processing is carried out after the print processing of XPS data. This security processing is one in which the structure of the XPS data after decompression is analyzed, a judgment is made as to whether or not the element is an important one, and if it is an important element, it is overwritten and erased. These operations are carried out by the security processing section 38 (or by the security processing program).

Since the Steps S100 to S600 of FIG. 8 are similar to those of FIG. 5, their description is omitted here, and the details of the security processing of Step S700 is described here referring to the flow chart of FIG. 9 and the concrete structure of XPS data of FIG. 10.

The security processing section 38, to begin with, in Step S701, searches for the XPS data inside the HDD 32, and after analyzing the structure of the XPS data and specifying the individual elements, in Step S702, carries out judgment as to whether or not each element is an important element in terms of security. For example, as shown in Table 1, among the constituent elements of XPS data, for the page information, image data, thumbnail data, Print Ticket, and font data, the level of importance is set from 5 to 1 in an order starting from the highest importance, and the level of importance of 0 is set to all other elements. Further, the security processing section 38, based on whether the level of importance of each individual element is above a predetermined level, carries out a judgment as to whether the element is an important one (that is, whether the element is the target of erasure). Further, the method of specifying the value indicating the level of importance can be any method, and it is possible to set the level of importance from 1 to 5 in an order starting from the highest importance.

TABLE 1
Example of important file judgment criteria

| Level of | | |
|---|---|---|
| Importance | Item | Description |
| 5 | Page information | Data of a page |
| | (*.fpage) | Text data and graphic data |
| | | described in the page |
| 4 | Image data | Image data pasted in |
| | (*.jpg, *.tiff, *.png, | the page |
| | and others) | |
| 3 | Thumbnail data | Thumbnail data |
| | | Reduced image of page |
| 2 | Print Ticket | Print control command |
| | | Includes file name/user |
| | | name, and print information |
| 1 | Font data | Subset data of fonts used |
| | | in the document |

Next, in Step S703, the elements that have been judged to be important (for example, elements with a level of importance 1 or higher, or the elements shown in hatched boxes in FIG. 10) are processed according to a publicly known algorithm (reference URL: http://www.pasokonippatu.com/shokyo.htm) such as the American National Security Agency (NSA) method, the zero writing method, random number writing method shown in Table 2, or some other method, so that they cannot be recovered from the HDD 32 (hereinafter called the overwriting and erasing).

TABLE 2
Examples of overwriting erasing methods

| Algorithm | Description |
|---|---|
| American National | This is the method of overwriting three times according to the standards of |
| Security Agency (NSA) | the American National Security Agency (NSA), and the writing is done |
| method | randomly in units of a sector. After that, again, a random value is |
| | overwritten in units of a file. Further, this time, a physical disk formatting is |
| | done. This is a method used in a large number of data erasing software |
| | programs, and is known to make it possible to erase data definitely although |
| | it takes time. In the case of this method, it is almost difficult to analyze the |
| | data even if an apparatus that reads out residual magnetism is used. The |
| | security level is about Medium. |
| Zero writing method | Overwriting is done with a null value (while this means that there is nothing in |
| | terms of data, the overwriting is done with null data). The values are written |
| | as sector information. Because of carrying out this operation, recovering |
| | ordinary data becomes impossible. In order to recover the data in the hard |
| | disk in this condition, it is necessary to read out the minute magnetism |
| | remaining on the disk, and to cancel out the null value data, the most |
| | common method is physical formatting. This method can be implemented |
| | using a disk formatter that is provided along with each of the different |
| | operating systems (OS), and data recovery becomes impossible with a one |
| | time processing. |
| Random number writing | Overwriting is done using random numbers and the random numbers are |
| method | generated by software. This value is obtained not as a numerical value but |
| | as a value for each span in hexadecimal notation. The actual data erasing |
| | operation is done in each sector which is a unit of data management in hard |
| | disks. Although there are differences in the size of a sector depending on |
| | the type of file formatting (disk formatting of hard disks dependent on each |
| | OS, such as FAT or NTFS), the management is often done with about 2 |
| | Mega to 4 Mega bytes. Because data writing is done randomly for such |
| | sectors, it is impossible to recover data by software. Further, even if |
| | scanning of residual magnetism is made, since random numbers are |
| | written unlike physical formatting, it takes an extremely long time to read out |
| | the erased data. The security level can be said to be low as a data erasing |
| | method. |

After that, in Step 3704, a judgment is made as to whether the verification of all the elements has been completed, and if there are any elements that have not been verified yet, similar processing is repeated after returning to Step S701, and when the verification of all the elements has been completed, the security processing program is ended.

In this manner, in the present preferred embodiment, since the XPS data decompressed and stored in a secondary storage device such as the HDD 32 is analyzed, a judgment is made as to whether each individual element is an important element according to a predetermined level of importance, and only important elements are overwritten and erased, it is possible to shorten the processing time compared to the method of overwriting and erasing all the elements of the XPS data.

As an example, to what extent the processing speed is improved by adopting the security processing of the present preferred embodiment is described here. If the size of the XPS data after decompression is 2289664 bytes and the size of the important elements within that (the size of elements with a level of importance of 1 or higher) is 1907268 bytes, the size of the important elements is about 83.3% of the size of the XPS data after decompression. Here, since the processing time of overwriting and erasing is proportional to size to be overwritten and erased, a processing speed improvement of 16.7% can be expected in the case when only the important elements are deleted.

### Preferred Embodiment 2

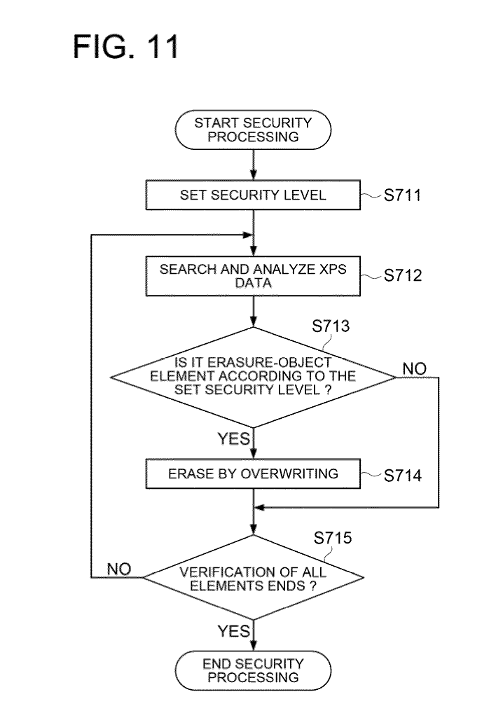

Next, the image forming apparatus and the security control method together with the security processing program according to a second preferred embodiment of the present invention are described below with reference to FIG. 11. FIG. 11 is a flow chart showing the print processing of XPS data according to the present preferred embodiment.

In the first preferred embodiment described above, although overwriting and erasing was done uniformly for elements with levels of importance from 1 to 5, depending on the user or the print data, there are cases in which it is desired to overwrite and erase completely giving priority to security, and there are also cases in which it is desired to give priority to performance while sacrificing the security to some extent. In view of this, in the present preferred embodiment, by specifying the security level in the PJL (Printer Job Language) or the like, it is made possible for the user to specify elements of up to which level are to be overwritten and erased.

The security processing flow in the present preferred embodiment is shown in FIG. 11.

In the present preferred embodiment, to begin with, in Step S711, the control section analyzes the PJL command added to the XPS data, and sets the security level according to the instruction in the PJL command. An example of the PJL command is shown in Table 3. However, Table 3 is merely one example, and it is also possible to set the security levels in finer detail.

TABLE 3
Example of security level PJL specification

| Security Level | |
|---|---|
| 0 | All elements are overwritten and erased. |
| 1 | Elements of importance level 5 are overwritten and |
| | erased. |
| 2 | No overwriting and erasing is done. |

Further, the security processing section 38, in Step S712, searches the XPS data inside the HDD 32, and in Step S713, carries out a judgment as to whether or not each element of the XPS data is the target of overwriting erasure according to the security level set earlier. Next, if the element is the target for overwriting erasure, in Step S714, the element is overwritten and erased so that it cannot be recovered from the HDD 32. After that, in Step S715, a judgment is made as to whether the verification of all the elements has been completed, and if there are any elements that have not been verified yet, same processing is repeated after returning to Step S711. When the verification of all the elements has been completed, the security processing is ended.

In this manner, by making it possible to set the security level, the user can control the security with a degree of freedom.

As an example, to what extent the processing speed is improved by adopting the security processing of the present preferred embodiment is described here. If the size of the XPS data after decompression is 2289664 bytes, the size of the page information is 1743428 bytes, image is 147456 bytes, thumbnail is 0 bytes, Print Ticket is 8192 bytes, and font data is 8192 bytes, the size of the elements with the importance level 5 (page information) is about 76.1% of the size of the XPS data after decompression. Here, since the processing time of overwriting and erasing is proportional to the size of file to be overwritten and erased, it is possible to expect a processing speed improvement of about 24% in the case when only the elements with the importance level 5 are deleted. Further, compared to when elements with levels of importance of 1 or higher are deleted, a processing speed improvement of about 8.6% can be expected.

Further, in the above, although the configuration was made such that the security level was set using the PJL command added to the XPS data, it is sufficient if such a command can be recognized by the image forming apparatus 30 and is not restricted to PJL commands. Further, in the above, although the configuration was made such that the PJL command was added to the XPS data in the computer terminal 20 and transmitted to the image forming apparatus 30, it is also possible to display a screen in the display and operation section 35 of the image forming apparatus 30 for setting the security level, and to make it possible for the user to set the security level in the image forming apparatus 30.

Further, in the above preferred embodiment, although descriptions were given for the security control of XPS, the present invention is not restricted to the above preferred embodiments, but can be applied in a similar manner to all document data stored in a secondary storage device such as the HDD 32 at the time of printing.

The present invention can be used in image forming apparatuses that carry out printing using a secondary storage device such as an HDD in the security control method in such image forming apparatuses, and in the security processing programs that operate in such image forming apparatuses.

According to the image forming apparatus and the security control method together with the security processing program according to the present invention, by erasing the XPS data stored in a secondary storage device such as an HDD, it is possible to ensure security. In addition, by making only the important elements in an XPS data become the target of erasure, it is possible to shorten the time required for erasing.

What is claimed is:

1. An image forming apparatus which receives XPS data and conducts print processing based on the XPS data, the image forming apparatus comprising:
a secondary storage device which stores the XPS data therein after decompression of the XPS data; and
a security processing section which specifies an element having a level of importance more or not less than a predetermined level from constituent elements of the XPS data decompressed in the secondary storage device and which erases the specified element by overwriting after the print processing, the level of importance having been set in advance.

2. The image forming apparatus of claim 1,
wherein the predetermined level is set based on a command added in advance to the XPS data.

3. The image forming apparatus of claim 1,
wherein the element having the level of importance above the predetermined level includes at least one of page information, image data, thumbnail data, Print Ticket and font data.

4. A security control method in an image forming apparatus which conducts print processing based on XPS data comprising the steps of:
decompressing compressed XPS data in a secondary storage device;
converting the decompressed XPS data into bit map data;
conducting print processing based on the bit map data;
specifying an element having a level of importance above a predetermined level from constituent elements of the XPS data decompressed in the secondary storage device, the level of importance having been set in advance; and
erasing the specified element by overwriting after the print processing.

5. The security control method of claim 4,
wherein, before the step of specifying, a command added to the XPS data in advance is analyzed and the predetermined level is set based on the command.

6. The security control method of claim 4,
wherein the element having the level of importance above the predetermined level includes at least one of page information, image data, thumbnail data, Print Ticket and font data.

7. A computer-readable recording medium having a security processing program stored therein to be executed by a computer in an image forming apparatus which decompresses compressed XPS data in a secondary storage device and conducts print processing,
wherein the security processing program causes the computer to function as a security processing section which specifies an element having a level of importance above a predetermined level from constituent elements of the XPS data decompressed in the secondary storage device, the level of importance having been set in advance, and erases the specified element by overwriting after the print processing.

8. The computer-readable recording medium of claim 7,
wherein the predetermined level is set based on a command added in advance to the XPS data.

9. The computer-readable recording medium of claim 7,
wherein the element having the level of importance above the predetermined level includes at least one of page information, image data, thumbnail data, Print Ticket and font data.
